(19) United States
(12) Patent Application Publication
(10) Pub. No.: US 2007/0209245 A1
(43) Pub. Date: Sep. 13, 2007

(54) LICENSE PLATE MOUNTED ACCESSORY

(76) Inventor: Kenneth R. STRACUZZI, Southampton, PA (US)

Correspondence Address: HARNESS, DICKEY & PIERCE, P.L.C., P.O. BOX 828, BLOOMFIELD HILLS, MI, 48303, US

(21) Appl. No.: 11/683,708

(22) Filed: Mar. 8, 2007

Related U.S. Application Data
(60) Provisional application No. 60/780,194, filed on Mar. 8, 2006.

(51) Int. Cl. G09F 7/00

(52) U.S. Cl. 40/210

(57) ABSTRACT

A license plate mounted accessory includes a mounting member, a support member and a display member. The mounting member includes a first portion for receiving a fastener and a second portion for engaging a side of a license plate to prevent rotation of the mounting member relative to the license plate. The support member extends from the mounting member and includes a first end proximate the mounting member and a second end. The display member is suspended from the second end of the support member.

### CROSS-REFERENCE TO RELATED APPLICATIONS

This application claims the benefit of U.S. Provisional Application No. 60/780,194, filed on Mar. 8, 2006. The disclosure of the above application is incorporated herein by reference.

### FIELD

The present disclosure generally relates to accessories for mounting on vehicles.

### INTRODUCTION

Various accessories are known for mounting on vehicles. For example, bumper stickers are popular for displaying messages and advertising on automobiles. Also known are flags that can be mounted to vehicle windows.

### SUMMARY

In one particular aspect, the present disclosure provides a license plate mounted accessory including a mounting member, a support member and a display member. The mounting member includes a first portion for receiving a fastener and a second portion for engaging a side of a license plate to prevent rotation of the mounting member relative to the license plate. The support member extends from the mounting member and includes a first end proximate the mounting member and a second end. The display member is suspended from the second end of the support member.

According to another aspect, the present disclosure provides a license plate mounted accessory including a license plate frame, a support member and a display member. The license plate frame is adapted to mount to a license plate. The support member extends from the license plate frame and includes a first end proximate the mounting member and a second end. The display member is suspended from the second end of the support member.

Further areas of applicability of the present teachings will become apparent from the description and appended claims provided hereinafter. It should be understood that the detailed description and specific examples, while indicating the various examples of the present teachings, are intended for purposes of illustration only and are not intended to limit the scope of the teachings.

### BRIEF DESCRIPTION OF THE DRAWINGS

The present disclosure will become more fully understood from the below description and the accompanying drawings, wherein:

FIG. 1 shows a pair of vehicle accessories constructed in accordance with the teachings of the present disclosure, the vehicle accessories illustrated operatively associated with a vehicle license plate.

FIG. 2 is a side view of one of the vehicle accessories of FIG. 1, the vehicle accessory shown operatively associated with a vehicle license plate and mounting screw, the mounting screw shown prior to attachment.

FIG. 3 shows a front view of one of the vehicle accessories of FIG. 1, the vehicle accessory shown removed from the license plate for purposes of illustration.

FIG. 4 shows a rear view of the vehicle accessory of FIG. 3.

FIG. 5 shows an enlarged rear view of the mounting portion of the vehicle accessory of FIGS. 3 and 4.

FIG. 6 shows an enlarged side view of the mounting portion of the vehicle accessory of FIGS. 3 and 4.

### DESCRIPTION OF VARIOUS ASPECTS

The following description is merely exemplary in nature and is in no way intended to limit the scope of the present disclosure.

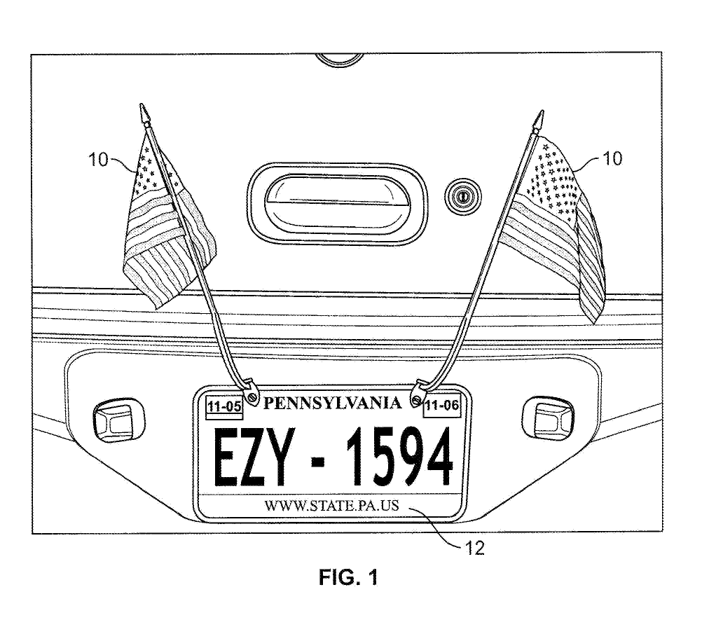

With initial reference to FIG. 1, a pair of vehicle accessories are illustrated and generally identified at reference character 10. The vehicle accessories 10 may be substantially identical in construction. The vehicle accessories are shown operatively associated with a vehicle license plate 12.

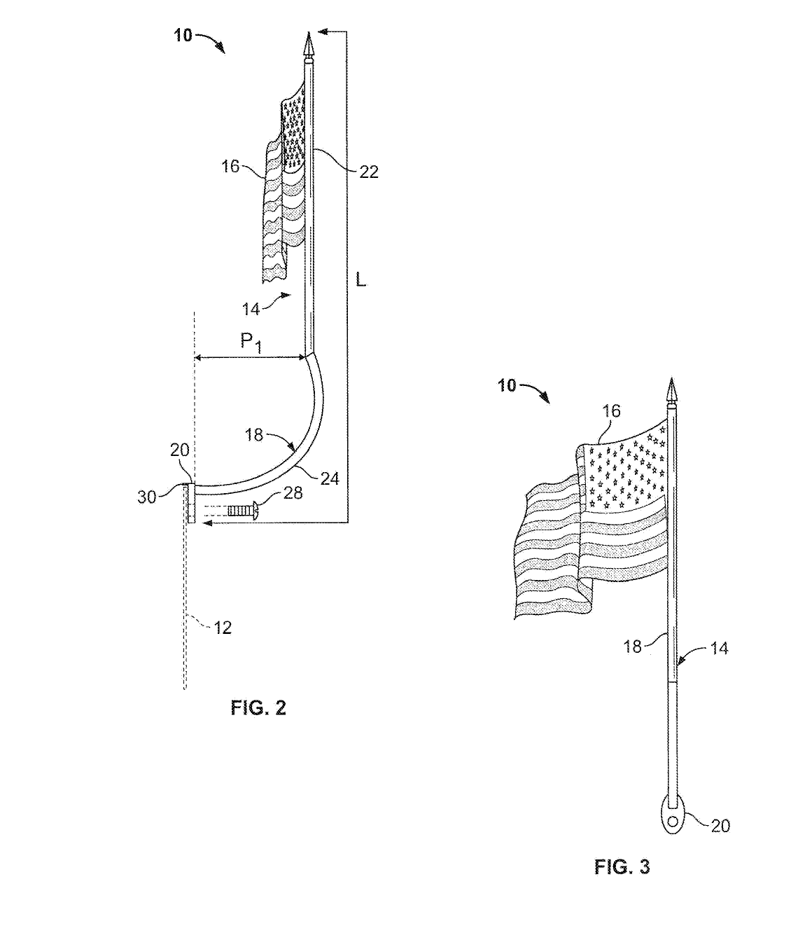

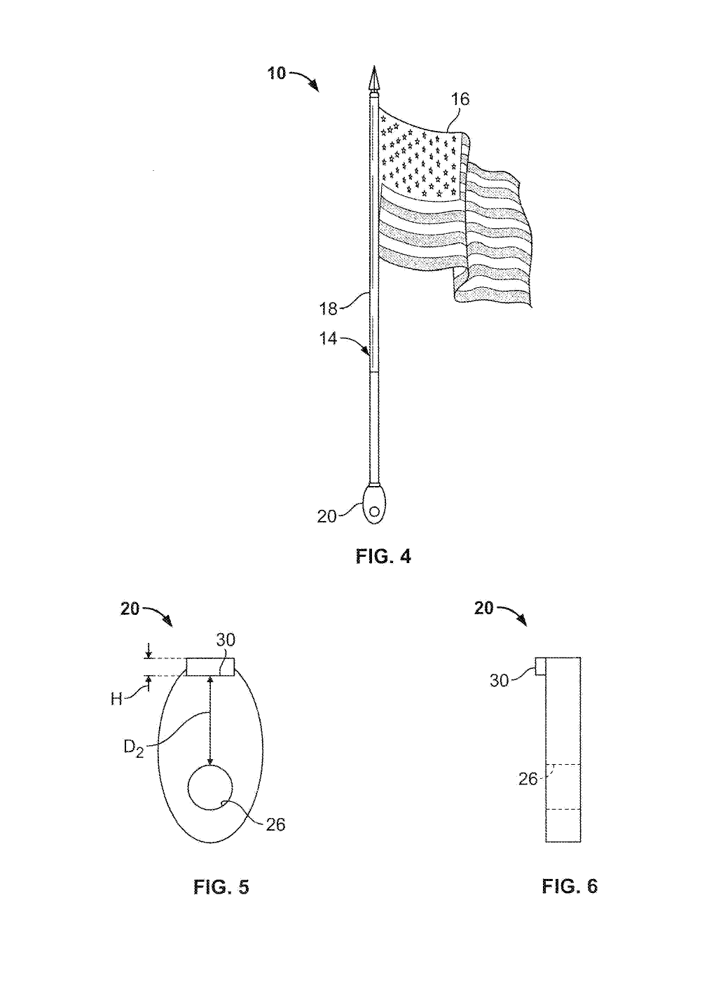

With continued reference to the environmental view of FIG. 1 and additional reference to FIGS. 2 through 6, one of the vehicle accessories 10 will be further described. The vehicle accessory 10 may generally include a first component 14 and a second component 16. The first component 14 may be integrally formed to include a shaft or pole portion 18 and a mounting portion 20. The first component 14 may be injection molded of a plastic material. Alternatively, the first component 14 may be formed of any material having suitable strength and durability characteristics for the intended purpose.

The shaft portion 18 may include an upper segment 22 and a lower segment 24. The upper segment 22 may be generally linear and may extend in a generally vertical direction. The lower segment 24 may be arcuate such that it extends upwardly and outwardly from the mounting portion 20. In this manner, the upper segment 22 is horizontally spaced from the license plate 12.

The mounting portion 20 may be generally oval in shape. Alternatively, the mounting portion 20 may be circular, square or of any other geometry. The mounting portion 20 may define an aperture 26 for receiving a fastener 28. The fastener 28 may be a fastener conventionally used to secure a license plate 12 to a vehicle.

The mounting portion 20 may additional include an anti-rotation feature 30. The anti-rotation feature 30 may be integrally formed with the mounting portion 20 and may be in the form of a rearwardly extending flange or tab. The anti-rotation feature 30 may be positioned so as to extend proximate an upper edge of the license plate 12 and thereby preclude undue rotation of the accessory 10 relative to the license plate 12.

In one particular application, the first component 14 may be constructed of round plastic with a diameter of approximately 0.22 inches and has a length L from a bottom of the mounting portion 20 to a top of the shaft portion 18 of approximately 12.0 inches. In this particular application, the upper end of the lower segment 24 is a horizontal distance D₁ from the mounting portion 20 of approximately 3.0 inches. The anti-rotation feature 30 may have a height H of approximately 0.15 inches and may be positioned a distance D₂ from the aperture 26 of approximately 0.55 inches. The aperture 26 may have a diameter of approximately 0.275 inches. Those skilled in the art will readily appreciate that the various dimensions provided above are merely exemplary and may be modified for particular applications.

The second component 16 of the vehicle accessory 10 may comprise a display portion. In one application, the display portion 16 may be a flag portion. The flag portion 16 may be constructed of substantially flexible fabric or plastic. Alternatively, the flag portion 16 may be constructed of substantially rigid material. In one application, the flag portion 16 has dimensions of approximately 4.0 inches by 6.0 inches. Again, those skilled in the art will readily appreciate that these dimensions are merely exemplary and may be modified for particular applications.

The flag portion 16 may have the appearance of the flag of the United States of America (as shown throughout the drawings) or the appearance of the flag of any other nation, state, group or the like. The flag portion 16 may alternatively show support for a particular school. For example, accessories 10 constructed in such a manner may be affixed to the vehicles of alumnae supporting their sports teams or their school in general. Still alternatively, the flag portion 16 may show support for causes such as breast cancer awareness, prisoners of war or the like, depending on the particular interests of the vehicle owner.

The second component 16 may be attached to the first component 14 in any manner well known in the art. For example, the second component 16 may be ultrasonically welded, glued or otherwise suitably attached to the first component 14.

In certain applications, it may be desirable to removably attach the flag portion 16 to the pole portion 14. In this manner, the vehicle owner may choose between various flag portions 16 depending on the particular destination of the vehicle. For example, if the vehicle is headed to a tailgate for a football game involving the driver's alma mater and its interstate rival, the vehicle owner may choose to adorn the vehicle with a flag portion 16 supporting the alma mater. At other times, the vehicle owner may choose to display support for various other causes. Such interchangeability may be alternatively facilitated through a first component constructed of discrete elements that can be removably secured to one another.

In other embodiments, it may be desirable to form the shaft portion 18 integral with a license plate frame. In this regard, the shaft portion 18 and the license plate frame may be injection molded of a common plastic, for example. In this manner the mounting portion 20 described above would be effectively eliminated.

The foregoing discussion discloses and describes merely exemplary arrangements of the present disclosure. One skilled in the art will readily recognize from such discussion, and from the accompanying drawings, that various changes, modifications and variations can be made therein without departing from the spirit and scope of the invention.

What is claimed is:

1. A license plate mounted accessory comprising:
a mounting member including a first portion for receiving a fastener and a second portion for engaging a side of a license plate to prevent rotation of the mounting member relative to the license plate;
a support member extending from the mounting member, the support member including a first end proximate the mounting member and a second end; and
a display member suspended from the second end of the support member.

2. The license plate mounted accessory of claim 1, wherein the support member extends upwardly and outwardly from the first portion of the mounting member.

3. The license plate mounted accessory of claim 1, wherein the support member includes at least a portion that is arcuate.

4. The license plate mounted accessory of claim 1, wherein in the second portion is a flange extending from the first portion.

5. The license plate mounted accessory of claim 1, wherein the display member is a flexible flag.

6. The license plate mounted accessory of claim 1, wherein the mounting member and the support member are integrally formed.

7. The license plate mounted accessory of claim 1, wherein the mounting member and the support member are injection molded.

8. A license plate mounted accessory comprising:
a license plate frame for mounting to a license plate;
a support member extending from the license plate frame, the support member including a first end proximate the mounting member and a second end; and
a display member suspended from the second end of the support member.

9. The license plate mounted accessory of claim 8, wherein the support member extends upwardly and outwardly from the license plate frame.

10. The license plate mounted accessory of claim 8, wherein the support member includes at least a portion that is arcuate.

11. The license plate mounted accessory of claim 8, wherein in the second portion is a flange extending from the first portion.

12. The license plate mounted accessory of claim 8, wherein the display member is a flexible flag.

13. The license plate mounted accessory of claim 8, wherein the license plate frame and the support member are integrally formed.

14. The license plate mounted accessory of claim 8, wherein the license plate frame and the support member are injection molded.
